(19) United States
(12) Patent Application Publication
(10) Pub. No.: US 2025/0250147 A1
(43) Pub. Date: Aug. 7, 2025

(54) ELECTRIFIED CONSTRUCTION AND/OR MATERIAL HANDLING MACHINE, IN PARTICULAR CRANE

(71) Applicant: Liebherr-Werk Biberach GmbH, Biberach an der Riss (DE)

(72) Inventors: Martin ASSFALG, Attenweiler (DE); Gerhard SCHMID, Wolpertswende (DE)

(73) Assignee: Liebherr-Werk Biberach GmbH, Biberach an der Riss (DE)

(21) Appl. No.: 19/184,663

(22) Filed: Apr. 21, 2025

Related U.S. Application Data
(63) Continuation of application No. PCT/EP2023/079132, filed on Oct. 19, 2023.

(30) Foreign Application Priority Data
Oct. 21, 2022 (DE) 10 2022 127 920.0

(51) Int. Cl. B66C 13/12; B60L 1/00; B60L 50/61; B60L 53/14; B60L 53/30; B60L 53/51; B60L 53/54; B60L 53/60; B60L 58/12; B66C 13/22; B66C 13/28

(52) U.S. Cl. CPC B66C 13/12; B60L 1/003; B60L 50/61; B60L 53/14; B60L 53/305; B60L 53/60; B60L 58/12; B66C 13/22; B60L 53/51; B60L 53/54; B60L 2200/40; B60L 2240/54; B66C 13/28

(57) ABSTRACT

The present invention comprises an electrified construction and/or material handling machine, in particular a crane, with electric drives for driving working assemblies, an electric energy store for supplying the electric drives with power, and a charging device for recharging the energy store, wherein the charging device has various charging interfaces for charging the energy store from various power supplies comprising at least one machine-integrated power generator and an external power supply.

### CROSS-REFERENCE TO RELATED APPLICATIONS

This application is a continuation of International Patent Application Number PCT/EP2023/079132 filed Oct. 19, 2023, which claims priority to German Patent Application Number DE 10 2022 127 920.0 filed Oct. 21, 2022, which are incorporated herein by reference in their entireties.

### BACKGROUND

The present invention relates to an electrified construction and/or material handling machines, in particular a crane, with electric drives for driving working assemblies, an electric energy store for supplying the electric drives with power and a charging device for recharging the energy store.

Various construction and/or material handling machines such as cranes are at present already fully electrically powered, whereas in case of other types of construction machinery, in which the electric drives are powered by a generator driven by an internal combustion engine, the process of converting from the previously predominant diesel-electric drive concept to fully electric operation is still underway. For example, cranes such as tower cranes are already operated fully electrically, wherein the cranes at a construction site can be connected to an external grid supply that is suitable for crane operation and provides, for example, power and voltage magnitudes in the range of 400V or 32 A or 63 A, usually three-phase. From such a power supply there is supplied the electric drive of a main working assembly, such as the lifting mechanism drive for actuating the hoist cable or load hook of a crane, or the electric drive of other core working assemblies that fulfill core functions of the respective construction machine, for example the luffing gear drive for luffing the jib of a crane or a cable excavator up and down, or the slewing mechanism drive for driving the crane or excavator jib around an upright axis of rotation, or the pump drive of a concrete pump.

However, if a power supply is not available at remote construction sites or if the power supply stationary at the construction site does not have sufficient power, it is difficult to ensure CO2-free operation of the construction and/or material handling machine. Until now, in the absence of a sufficiently strong power supply at a construction site, a diesel power unit has usually been used to generate power, which, in addition to the unavoidable CO2 emissions, also causes greater noise pollution and suffers from low energy efficiency. In order to absorb peak loads, for example when large loads have to be lifted, the diesel power unit set must provide a sufficiently high output, which is oversized or not required in idle mode or when the construction machine is moving with low loads, such as when the load hook of a crane is empty. The operation of such a diesel power unit results in higher CO2 emissions and corresponding noise pollution.

In this respect, it has already been proposed to equip construction and/or material handling machines with an electric energy storage system in order to be able to cushion load peaks by supplying power from the rechargeable battery, wherein recuperative power harvesting is also already used to charge the energy store when the machine operation releases kinetic energy, such as when braking a drive or lowering a load on the load hook using heavy force. Examples of electrified construction and/or material handling machines are shown in patent documents DE 20 2015 008 403 U1, DE 10 2021 102 706 A1 or EP 33 50 111 B1.

It is the underlying object of the present invention to provide an improved electrified construction and/or material handling machine of said type, in particular an improved crane, which avoids disadvantages of the prior art and further develops the latter in an advantageous manner. In particular there should be achieved CO2-free or low CO2-emission and energy self-sufficient operations at sites without sufficient power grid, whereas the energy sources available are used efficiently, avoiding placing special demands on the infrastructure of the construction site or the workplace. Preferably, it affects the elimination of noise and exhaust fumes during working hours, reducing stress for machine operators, construction workers and passers-by.

### SUMMARY

According to the invention, said task is solved by an electrified construction and/or material handling machine according to claim 1. Preferred embodiments of the invention are the subject-matter of the dependent claims.

It is therefore proposed to provide an intelligent charging structure that makes efficient use of available power supply sources and adjusts to the infrastructure available at the assembly site. According to the invention, the charging device comprises various charging interfaces for charging the energy store from various power supplies comprising at least an internal machine generator and an external power supply. This allows the energy store of the construction and/or material handling machine to be selectively connected to an external 6 power supply and recharged from this or, if such a supply is not available, to be recharged from the machine-integrated generator.

Said various charging interfaces can be adjusted to different voltage and/or current levels. In particular, for connection to and recharging from an external power supply that does not in itself provide the energy strengths and/or voltage and/or current levels required by the electric drives of the working assemblies, provision can be made for a charging interface. For example, if the electric drive of a main working unit such as the lifting mechanism drive of a crane requires a power supply in the range of 400V and/or 32 A or 63 A and/or a three-phase current, said low-power charging interface can nevertheless be configured to be connected to an external power supply with, for example, only 230V and 16 A or 400V at only 16 A and to recharge the energy store from such a “weak” power supply, which in itself is too weak to power the working assemblies of the machine itself, but is quite sufficient to recharge the energy store.

Advantageously, however, the charging device can also have, as an alternative or in addition to such a low-power charging interface, a fast-charging interface for connecting to a stronger power supply with, for example, 32 A or 63 A, so that the charging device can also recharge the energy store from such a stronger power supply.

If such a stronger external grid is available, the construction and/or material handling machine, i.e. its working assemblies, can also be operated directly from the grid without the working assemblies having to be fed from the machine-integrated energy store, which may nevertheless be the case, for example to cushion power peaks. The charging or energy control device can be configured to use the power coming from the external mains to operate the working assemblies and, if necessary, to charge the energy store and to switch off the power supply to the working assemblies from the energy store or limit it to short time windows of peak loads.

However, if no external power supply is available at all or if such a power supply is too weak, the energy store can also be recharged from the machine-integrated generator, wherein the construction and/or material handling machine can, in a further development of the invention, have an internal combustion engine, such as a diesel engine, in order to drive said generator. This can also enable self-sufficient machine operation at locations without a power supply.

Advantageously, however, the internal combustion engine for controlling the machine-integrated generator is intelligently controlled by a charge control device, in particular in dependence on the state of charge and/or demand of the energy store, in order to reduce noise and/or exhaust gases and/or to shift them to phases that are less stressful for machine operators, workers and passers-by.

Advantageously, said charge control device can be configured to operate the internal combustion engine only when charging from an external power supply is not possible or not sufficient.

Alternatively, or additionally, the charge control device can also only operate the internal combustion engine when the state of charge or demand of the energy store actually requires it. In particular, the internal combustion engine can be started automatically if, for example, a peak load requires this or the state of charge of the energy store is not sufficient for a job to be carried out, for example because a large load has to be lifted.

In this case, the charge control device can also advantageously take into account external information, for example from a construction site management computer or a so-called BIM, i.e. a construction site information model, in particular in such a way that the current state of charge of the energy store is compared with the energy requirements of an upcoming or future work process and a charging process is started, for example the internal combustion engine is started in order to charge the energy store in good time and to recharge it sufficiently for the upcoming job.

Alternatively, or additionally, the charge control device can also postpone the charging process, for example the operation of the internal combustion engine, to a less disruptive time when there are fewer workers at a construction site or noise pollution in the neighborhood is perceived as less disruptive. For example, the charge control device can operate depending on the time of day.

In particular, the charge control device can be configured to operate the internal combustion engine for driving the machine-integrated generator only for a limited time in the rated power range or in a limited window around the rated power range in which the internal combustion engine has a relatively low consumption or a favorable consumption/power ratio and/or exhibits favorable exhaust gas behavior. In contrast to the previous use of diesel power units, which run in idle mode during the total machine operation or working day with the exception of short load peaks when high loads are moved, a significantly more efficient charging of the energy store with less noise and exhaust gas pollution can be achieved by operating in an interval-like manner in the rated power range.

Said charge control device can detect the state of charge of the energy store by means of a charge sensor system and control the charging process depending on the detected state of charge, for example starting the internal combustion engine for controlling the machine-integrated generator, wherein the charge control device can advantageously also take into account the charge demand of the rechargeable battery for future operating phases, for example by means of information from a construction site management computer and/or from a BIM and/or a work planning device, which provides future jobs of the machine and/or energy demand information for future operation.

In a further development of the invention, the charging device can also have other charging interfaces, for example for connecting to and charging from fuel cells or solar panels, wherein the respective charging interface is adjusted to the power supply characteristics, in particular the voltage and/or current level, of the respective power supply.

In an advantageous further development of the invention, the charge control device can provide for automated switching between the various charging interfaces, in particular in dependence on the energy supply power stationary at the various charging interfaces and/or the respective state of charge and/or charge demand of the energy store. Advantageously, in this case, the charge control device can be configured to recharge primarily from a locally emission-free charging interface, such as the mains supply interface, and only switch on the internal combustion engine to operate the machine's own generator as required.

The energy store can be permanently installed in the construction and/or material handling machine. Alternatively, however, a removable energy storage unit can also be provided.

Regardless of whether the energy store is permanently installed or removable, the storage connection point to which the energy store is connected can advantageously be configured in an intelligent manner, for example have a sensor system or be connectable to a sensor system that can detect the state of charge of the energy store. Alternatively, or additionally, the storage interface can have a communication device to transmit information about the connected energy store to the charge control device, for example the storage type and/or the state of charge.

For example, the storage interface can have a communication device that can communicate with the charge control device wirelessly, for example via radio or light signals, or also by cable.

The charge control device can provide charging intervals that are relatively short in comparison to the machine operating time, for example viewed as a whole less than 50% or less than 30% of the machine operating time, wherein individual intervals can be shorter than 40% or shorter than 30% or shorter than 20% of the machine operating time, for example, wherein said machine operating time can be the daily operating time of the machine. For example, if a crane such as a tower crane is used for four hours a day at a construction site, charging intervals of less than three hours or less than two hours or less than one hour may be provided.

Advantageously, the charging device can have one or more charging interfaces that are configured to be connected to an external power supply and to charge the energy store from this, which are single-phase or multi-phase and/or provide direct current or alternating current and/or provide different voltage levels. In this case, the respective charging interface and/or the charging device can be configured to adjust the power received from the connected external power supply to the battery store, for example to convert a multi-phase current into a single-phase current and/or to convert alternating current into direct current or to perform other current-directing or inverting functions that make the power received suitable for the energy store.

In an advantageous further development of the invention, the energy store can be directly and/or fully integrated into the power supply of the electric drives of the working assemblies, so that the respective electric drive can operate directly from the direct current supply of the energy store. In particular, direct DC connections between the energy store and the electric drives can be provided and/or AC or DC rectifier power modules can be dispensed with.

In particular, the energy store can be connected to the electric drives in such a manner that the DC voltage of the energy store does not first have to be converted into an AC voltage, which is then converted back into a DC voltage or a DC current by the power electronics of the construction and/or material handling machine and, if necessary, stored in the power electronics, for example via a frequency converter, phase control module or other inverter or rectifier, in order to then, for example, use a frequency converter to generate an alternating voltage, which is usually three-phase, in order to control a continuously variable speed drive.

The energy store can be integrated into the power supply of the electric drives in such a manner that the DC voltage provided by the energy store can be supplied to the electric drives of the working assemblies without conversion via AC and/or DC converters.

The aforementioned machine-integrated generator or a further machine-integrated generator need not necessarily be driven by said combustion engine in order but can also be connected to a movable machine element and/or a drive train of the construction and/or material handling machine in order to convert kinetic energy of the machine element and/or the drive train into electricity in generator mode, for example to recover energy during braking operations or lowering movements of a load, which can be used to recharge the energy store.

For example, the generator can simultaneously form an electric motor for driving a working assembly, which can provide energy by recuperation in braking operation and/or drag operation and make it available for recharging the energy store.

For example, said generator can be assigned to a hoist of the crane in order to be driven in generator mode when lowering a load on the crane's load hook and to generate electricity that is then used to recharge the energy store.

In particular, the generator can also be assigned to a traction drive of the construction and/or material handling machine in order to feed the energy back into the electric energy store by means of recuperation when driving downhill or braking. If the said generator is assigned to the traction drive, the generator can also support the traction drive in a motor-like manner or be configured for the independent operation of the traction drive.

It is advantageous if such a recuperative generator can be provided in a sub-frame of the construction and/or material handling machine, which undercarriage comprises a chassis for moving the construction and/or material handling machine and/or a traction drive for moving the construction and/or material handling machine, so that the generator can be driven by traction movements of the construction and/or material handling machine or can recover energy in order to recharge the energy store.

If the construction and/or material handling machine has a movable undercarriage and a superstructure carried on it, the upper and lower carriages can have separate energy supply systems and/or separate energy storage systems. For example, an electrical energy store can be provided on the undercarriage and an electrical energy store on the superstructure in order to supply working assemblies on the undercarriage and working assemblies on the superstructure.

In an advantageous further development of the invention, the energy storage systems and/or the energy supply systems on the undercarriage on the one hand and on the superstructure on the other can be connected to one another bidirectionally in order to be able to conduct electric energy from the undercarriage to the superstructure and vice versa from the superstructure to the undercarriage. In particular, energy can be conducted from a generator on the undercarriage to an energy store on the superstructure and/or energy can be conducted from the energy store on the superstructure to a motor on the undercarriage. Alternatively or in addition, energy can be conducted from a generator on the superstructure to an energy store on the undercarriage and/or energy can be conducted from an energy store on the undercarriage to a motor on the superstructure.

### BRIEF DESCRIPTION OF THE DRAWINGS

The invention is explained in more detail below on the basis of a preferred exemplary embodiment and the corresponding drawings. The drawings show:

FIG. 1: shows a side view of a construction and/or material handling machine in the form of a mobile crane according to an advantageous embodiment of the invention, wherein on the machine side there are provided a diesel power unit, an energy store, at least one grid connection and a construction site power distributor,

FIG. 2: shows a side view of the mobile crane from FIG. 1 in an operating mode in which the electric drives of the mobile crane are powered via the grid connection of the mobile crane,

FIG. 3: shows a side view of the mobile crane from the previous figures in an operating mode in which the machine-integrated diesel power unit supplies the construction power distributor

FIG. 4: shows a side view of the mobile crane from the previous figures in an operating mode in which the electric drives of the working assemblies of the mobile crane, and possibly also the machine-side construction power distributor, are powered by the energy store of the mobile crane,

FIG. 5: shows a side view of the mobile crane from the previous figures in an operating mode in which the electric drives of the working assemblies of the mobile crane are powered by the energy store of the mobile crane and the energy store is recharged in parallel from the external construction site power supply,

FIG. 6: shows a side view of the mobile crane from the preceding figures in an operating mode in which the electric drives of the working assemblies of the mobile crane are powered from the electric energy store and said energy store is recharged from the diesel power unit, and

FIG. 7: shows a side view of the mobile crane from the previous figures in an operating mode in which the electric drives of the working assemblies are supplied from the energy store and the energy store is recharged from an external power supply and the machine-integrated power unit.

### DETAILED DESCRIPTION

As shown in the figures, the construction and/or material handling machine 1 can be configured as a crane 2, for example in the form of a mobile crane, but also in the form of other cranes such as a tower crane, or also in the form of another construction machine such as a cable excavator or a piling and/or drilling rig or a concrete pump.

As shown further in the figures, the construction and/or material handling machine 1 can have an undercarriage 3 with a traveling gear 4, which can be configured with multiple axes and can advantageously have a traction drive in order to be able to move the machine at a construction site and/or on the road.

Said undercarriage 3 can carry a superstructure 5, which can be pivoted about an upright axis by a slewing gear and, in the case of a crane 2, can carry a jib 6, from which a hoist cable can descend in a manner known per se, which carries a load hook and can be adjusted by a lifting mechanism drive. In the case of a telescopic boom crane, the jib 6 can be luffed about a horizontal luffing axis on the superstructure 5 and luffed up and down by a luffing gear. In the case of a mobile fast-erecting crane, however, the jib 6 can also be seated on a tower that can be erected on the superstructure 5. Depending on the crane design, a trolley can be moved along the jib 6 in order to lower the hoist cable to different radii.

In this case, the construction and/or material handling machine 1 comprises a plurality of electric drives for driving the working assemblies thereof, including the main working assembly, wherein the traction drive of the undercarriage 3 may also have an electric drive. In particular, electric drives can be provided for the said slewing gear for driving the superstructure 5, then for said lifting mechanism for raising and lowering the load hook and, if necessary, for the luffing gear for luffing the jib up and down and for the trolley drive for moving the trolley.

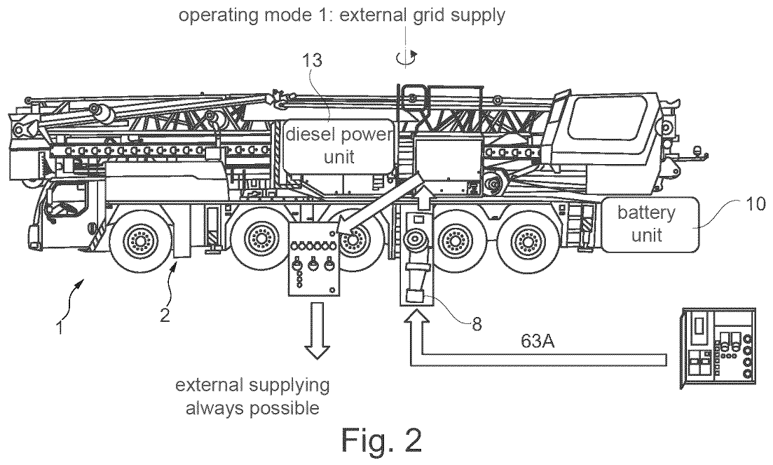

As shown in FIG. 2, said electric drives 7 can be supplied in a manner known per se from an external power supply, in particular via a grid connection 8 of the construction site. For this purpose, the construction and/or material handling machine 1 comprises a grid connection 8, via which the construction and/or material handling machine 1 can be connected to an external power supply 9.

In addition to such mains operation, however, the construction and/or material handling machine 1 can also be operated electrically from an energy store 10, wherein said energy store 10 can supply the aforementioned electric drives 7 of said working assemblies such as slewing gear, lifting mechanism, luffing gear and trolley chassis.

Said energy store 10 is advantageously configured to supply the complete working power of the construction and/or material handling machine 1 in the intended working mode without the need for additional energy sources such as the external power supply 9 that can be connected to the grid connection 8. In particular, said energy store 10 can also provide the peak and continuous power of the machine without requiring additional energy sources.

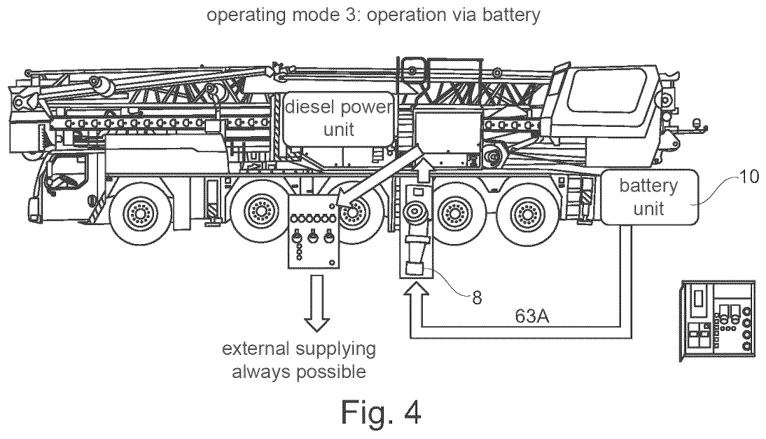

The crane 2 or the construction and/or material handling machine 1 can operate self-sufficiently electrically without emissions thanks to the energy store, without requiring a power supply, cf. FIG. 4.

Said energy store 10 can be configured in the form of a rechargeable battery or an arrangement of several rechargeable batteries, wherein additional storage components such as capacitors or double-layer capacitors can also be provided in order to be able to store 6 regenerated power for a short time and to a large extent. However, a rechargeable battery alone can also be provided as energy store 10.

In order to be able to recharge the energy store 10 with electric energy, the construction and/or material handling machine 1 has a charging device 11, which advantageously has various charging interfaces 12 for charging the energy store 10 from various power supplies, with at least one charging interface 12a for charging the energy store from an external power supply and at least one further charging interface 12b for charging the energy store 10 from the machine-integrated power generator 13.

Said machine-integrated power generator 13 may comprise a diesel power unit or generator 14, which may be driven by an internal combustion engine 15, for example a diesel engine.

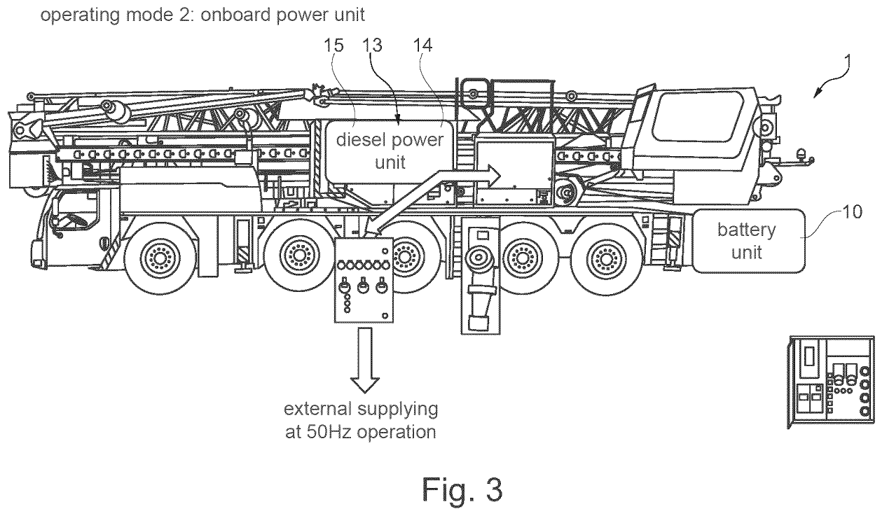

Advantageously, the machine-integrated power generator 13 can also be configured to take over the supply of the electric drives 7 of the machine when the energy store 10 is empty or damaged, thus ensuring machine operation without a mains supply and without an energy store, cf. FIG. 3.

A charge control device 16 controls the charging process in dependence on a state of charge and/or a charge demand of the energy store 10, wherein the state of charge of the energy store 10 can be detected by a sensor system 17 and reported to the charge control device 16. The charge demand, for example in order to be able to process a future lifting task of the crane 2 from the energy store 10, can be provided, for example, by a planning module 17, which can communicate with a construction site management computer or a BIM, i.e. a building information model, by means of a suitable communication device and retrieve or receive data there for tasks to be performed. The planning module 17 can be part of the charge control device 16.

Said charge control device 16 can comprise an electronic computer unit, for example with a microprocessor and a program memory, in which program routines to be processed can be stored, for example in the form of software that can be imported.

Said charge control device 16 can switch between the various charging interfaces 12 or enable and/or disable individually charging interfaces in order to be able to control the charging process.

In particular, said charge control device 16 can also control the machine-integrated power generator 13, in particular its internal combustion engine 15.

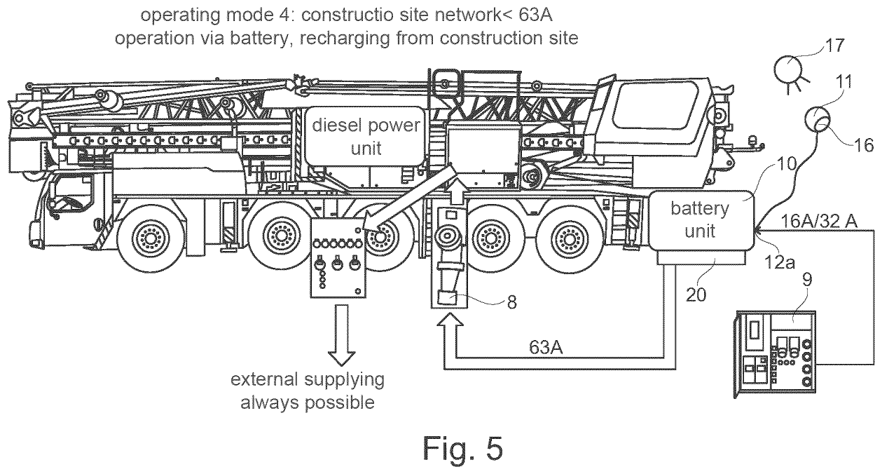

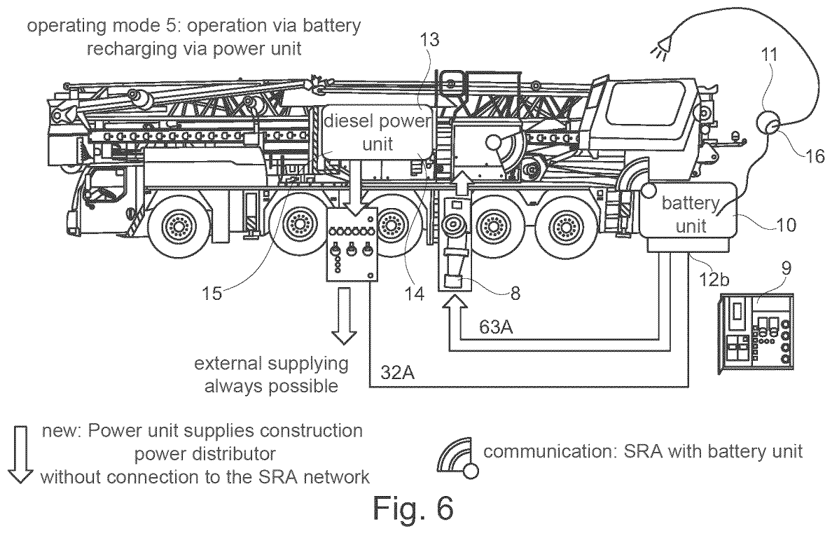

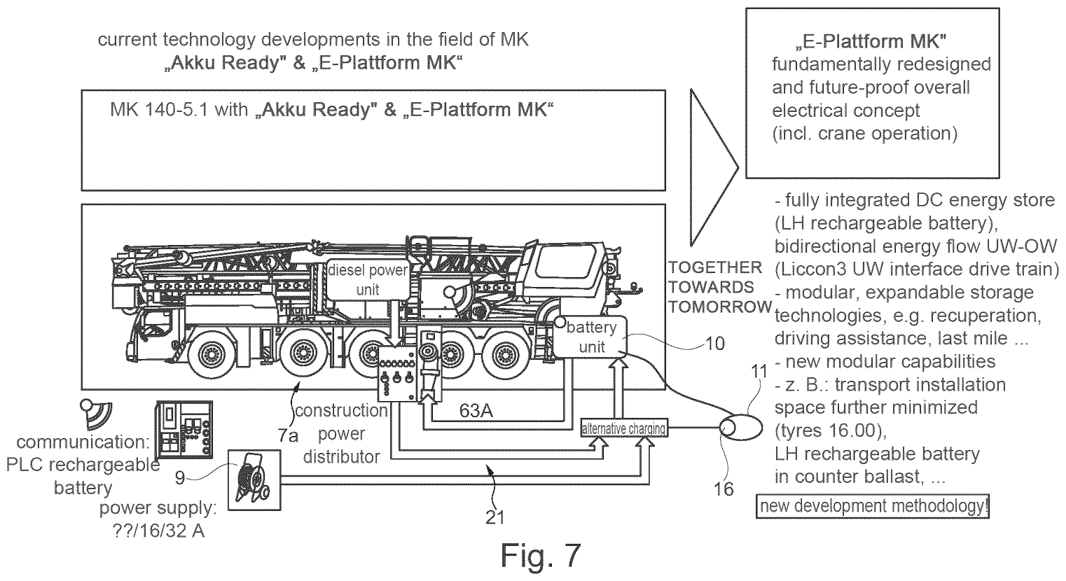

As FIGS. 5 to 7 show, the various charging interfaces 12 can be used for various charging strategies.

For example, the charge control device 16 can be configured to operate the internal combustion engine 15 at charging intervals in a rated power range and/or a power range in which the power/fuel consumption ratio is at a maximum.

In this case, the charge control device 16 can only operate the machine-integrated power generator 13 in an interval-like manner, wherein charging intervals, in which the machine-integrated power generator 13 is in operation, can be significantly shorter than non-charging intervals, in which the machine-integrated power generator 13 is switched off.

For example, the charging intervals viewed as a whole may be less than 50% or less than 30% of the machine operating time and/or viewed individually may be less than 30% or less than 20% of the machine operating time.

Advantageously, the charge control device 16 can operate the recharging of the energy store 10 primarily via the charging interface 12b, to which the external power supply 9 can be connected, and operate recharging via the recharging interface 12a, to which the machine-integrated power generator 13 can be connected, only on a secondarily basis, in particular only if no or sufficient power can be drawn via the charging interface 12b for the external power supply 9 in order to achieve low-emission and low-noise operation overall.

The charging interface 12b for recharging from the external power supply 9 can be configured to allow recharging from a weaker power supply 9, the power of which is below the power demand of the working assemblies of the construction and/or material handling machine and/or provides current and/or voltage magnitudes that are below the current and/or voltage magnitudes required by the working assemblies.

For example, the charging interface 12b may perform recharging operations at 230 volts and 16 amps or 400 volts and 16 amps.

Independently thereof, at least one further charging interface 12c, d may also be provided for charging the energy store 10 from a solar panel and/or from a fuel cell, and/or a charging interface may be provided for recharging from a direct current source.

In order to work efficiently, the energy store 10 can be integrated directly into the power supply of the electric drives 7 of the working assemblies and/or integrated into the power supply device of the electric drives 7 in such a way that the DC voltage provided by the energy store 10 can be made available to the electric drives 7 or their power electronics without prior conversion via inverters and/or rectifiers.

Advantageously, the one or a further machine-integrated power generator 13 for recuperative power harvesting can be connected or coupled to a movable machine element and/or a drive train of the construction and/or material handling machine, wherein the charging device 11 can be coupled to recharge the energy store 10 with the recuperatively harvested power, possibly for temporarily storing in an intermediate store.

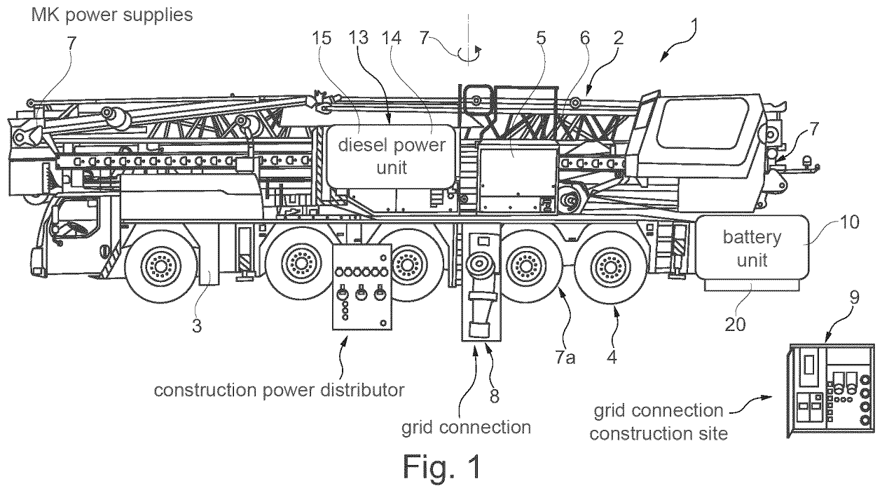

The electrified construction and/or material handling machine 1 can have an undercarriage 3 with a traveling gear 4 and an electric traction drive 7a, as well as a superstructure 5, which is configured as a rotating platform or can be rotatably mounted on the undercarriage 3 about an upright axis of rotation and can have the aforementioned electric drives 7 for driving working assemblies, cf. FIG. 1. In this case, a bidirectional connection can be provided between the electrical equipment of the undercarriage 3 and the electrical equipment of the superstructure 5 for transmitting power from the superstructure 5 to the undercarriage 3 and vice versa from the undercarriage 3 to the superstructure 5.

In particular, the energy store 10 can provide power to electric drives 7 both in the undercarriage 3 and in the superstructure 5 via said bidirectional connection 21 and/or can receive recuperatively harvested power both on the undercarriage and on the superstructure.

The crane 2 can be a mobile fast-erecting crane that can serve several construction sites every day. In addition to the external power supplies that can be used for crane operation, e.g. 400V, 3 ph, 32 A or 63 A, CO2-free crane operation is still possible if these are not available or if the external power supply is too low thanks to the intelligent rechargeable battery/battery unit 10.

The rechargeable battery unit 13 can be used to operate the crane 2 independently without any further external power supply, for example for one or more days depending on the energy capacity. The rechargeable battery 10 can be optimally recharged via the built-in power unit 13, wherein the internal combustion engine 15 can only run in the optimum rated power range for a short time during the day and thus shows low consumption and optimum exhaust gas behavior due to operation in the rated load range and does not have to run in idle mode during the total crane operation with the exception of short load peaks when loads are moved, as in previous use.

Recharging is preferably started automatically by intelligent communication between the crane and the rechargeable battery unit 10 via a “battery ready” interface, which in turn enables simplified operation and uninterrupted crane work. The rechargeable battery unit 10 can be a portable unit with a small energy content (payload e.g. on the equipment carrier) or permanently installed on the crane 2 with a larger energy content. The “rechargeable battery ready” interface can be implemented via radio, light signal or cable.

In addition to recharging the rechargeable battery 10 via the power unit 13, there is also the option of recharging via an external power supply 9 single-phase, multi-phase or DC charging as well as fast charging.

The rechargeable battery pack 10 is able to supply the peak and continuous power of the crane 2 without additional energy sources. The rechargeable battery 10 can be recharged using a significantly weaker power supply, e.g. 230V, 16 A or 400V, 16 A instead of 32 A or 63 A.

This recharging is also possible in parallel with crane operation.

Recharging can also be carried out using modern energy sources such as fuel cells or solar panels. Especially in inner-city areas, energy sources greater than 32 A are often not available and long cable runs have to be laid to operate the crane.

Advantageously, the rechargeable battery 10 can be completely integrated into the control concept, i.e. the crane 2 operates directly from the DC supply of the rechargeable battery. This has the advantage that 400V AC voltage does not first have to be generated from the rechargeable battery DC voltage, which is then temporarily stored again in the power section of the crane (e.g. frequency converter, phase control, . . . ) in a DC voltage from which, for example, the frequency converter generates an AC voltage (usually 3-phase) in order to drive a continuously variable speed drive.

Independently of this, an electric motor 7a, which can also operate as a generator, or a generator, which can also operate as a motor, can be installed in the undercarriage 3 of the mobile crane 2. This is preferably used to support the traction drive or to operate the traction drive independently. When driving downhill or braking, the energy can be fed back into a storage system provided for this purpose by means of recuperation.

The energy store systems from undercarriage 3 and crane superstructure 5 are preferably connected together in a bidirectional system so that the energy store(s) 10 or energy source(s) ideally complement each other during road travel or crane operation.

The energy storage system can be recharged during road travel or when stationary by the generator integrated in the undercarriage 3 or at a construction site by an external power supply.

We claim:

1. An electrified construction and/or material handling machine comprising:
a crane;
electric drives for driving working assemblies;
an electric energy store for supplying the electric drives with power; and
a charging device for recharging the energy store;
wherein the charging device comprises various charging interfaces for charging the energy store from various power supplies comprising at least one machine-integrated power generator and an external power supply.

2. The electrified construction and/or material handling machine of claim 1, wherein the machine-integrated power generator comprises an internal combustion engine, and the machine further comprises a charge control device for controlling the internal combustion engine in dependence on a state of charge and/or a charge demand of the energy store.

3. The electrified construction and/or material handling machine of claim 2, wherein the charge control device is configured to operate the internal combustion engine at charging intervals in a rated power range and/or a power range in which a power/fuel consumption ratio is maximized.

4. The electrified construction and/or material handling machine of claim 3, wherein the charge control device is configured to operate the machine-integrated power generator only in an interval-like manner, wherein the charging intervals in which the machine-integrated power generator is in operation in relation to a machine operating time of the construction and/or material handling machine are shorter than non-charging intervals in which the machine-integrated power generator is switched off.

5. The electrified construction and/or material handling machine of claim 4, wherein the charging intervals, as a whole, are less than 50% of the machine operating time and/or, individually, are less than 30% of the machine operating time.

6. An electrified construction and/or material handling machine of claim 2, wherein the charge control device is configured to operate the recharging of the energy store on a priority basis via a one of the charging interfaces, connectable to the external power supply, and to operate the recharging via the one of the recharging interfaces, connectable to which the machine-integrated power generator only on a secondarily basis if no power or insufficient power can be drawn via the one of the charging interfaces for the external power supply.

7. The electrified construction and/or material handling machine of claim 2, wherein the charge control device is configured to automatically start recharging as required and during machine operation.

8. The electrified construction and/or material handling machine of claim 2, wherein the charge control device is configured to communicate with a construction site management computer and/or a BIM server and to process charge demand data provided by a planning module, wherein the charge demand data characterizes the charge demand for future jobs of the construction and/or material handling machine, and to control the recharging of the energy store in dependence on said charge demand data.

9. The electrified construction and/or material handling machine of claim 2, wherein one of the charging interfaces for recharging from the external power supply is configured to allow recharging from a power from the power supply, the power of which is below the power demand of the working assemblies of the construction and/or material handling machine and/or provides current and/or voltage magnitudes which are below the current and/or voltage magnitudes required by the working assemblies.

10. The electrified construction and/or material handling machine according to claim 9, wherein the one of the charging interfaces for recharging from the external power supply is configured to perform recharging operations at 230 volts and 16 amperes or 400 volts and 16 amperes.

11. The electrified construction and/or material handling machine according to claim 9, wherein at least one further charging interface is configured to charge the energy store from a solar panel and/or from a fuel cell.

12. The electrified construction and/or material handling machine of claim 11, wherein the charging device comprises a further charging interface for recharging from a direct current source.

13. The electrified construction and/or material handling machine of claim 1, wherein the energy store is permanently installed.

14. The electrified construction and/or material handling machine of claim 1, further comprising a storage interface for connecting the one or a further energy store in a detachable, interchangeable manner.

15. The electrified construction and/or material handling machine of claim 14, wherein the storage interface comprises a sensor interface for connecting a state of charge sensor system for detecting the state of charge of the energy store connected thereto and/or a communication interface for communicating to the charging device the state of charge and/or energy store data characterizing the energy store and/or the operating state thereof.

16. The electrified construction and/or material handling machine of claim 1, wherein the energy store is integrated directly into the power supply of the electric drives of the working assemblies and/or is incorporated into a power supply device of the electric drives in such a manner that the DC voltage provided by the energy store is made available to the electric drives or their power electronics without prior conversion via inverters and/or rectifiers.

17. The electrified construction and/or material handling machine of claim 1, wherein the one or a further of the at least one machine-integrated power generator for recuperative power harvesting is connected or connectable to a movable machine element and/or a drive train of the construction and/or material handling machine, and wherein the charging device is configured to recharge the energy store with the recuperatively harvested power, optionally for temporarily storing in an intermediate store.

18. The electrified construction and/or material handling machine of claim 1, wherein the electric drives comprise a first electric traction drive and a second electric traction drive, the machine further comprising an undercarriage with a traveling gear and, the first 8 electric traction drive, and a superstructure mounted on the undercarriage rotatably about an upright axis of rotation, and comprising the second electric traction drive for driving working assemblies, the machine further comprising a bidirectional connection between first electric devices of the undercarriage and second electric devices of the superstructure for transmitting power from the superstructure to the undercarriage and from the undercarriage to the superstructure.

19. The electrified construction and/or material handling machine of claim 18, wherein the energy store is configured to provide power to the first and second traction electric drives via said bidirectional connection and/or can receive recuperatively harvested power on the undercarriage and the superstructure.

20. The electrified construction and/or material handling machine of claim 1, wherein the crane has a jib from which a hoist cable descends, and is actuatable by a lifting mechanism, wherein the electric drives of the lifting mechanism are configured to be driven from the energy store.
